(19) United States
(12) Patent Application Publication
(10) Pub. No.: US 2026/0335997 A1
(43) Pub. Date: Oct. 29, 2026

(54) WORKPIECE CARRIER ASSEMBLY FOR A CUTTING SYSTEM

(71) Applicant: MITEK HOLDINGS, INC., Wilmington, DE (US)

(72) Inventor: Michael Jacober, Highland, IL (US)

(21) Appl. No.: 19/188,747

(22) Filed: Apr. 24, 2025

(51) Int. Cl. B23D 51/04

(52) U.S. Cl. CPC B23D 51/043

(57) ABSTRACT

A cutting system for a workpiece, associated components and methods. The cutting system includes a housing bounding a cutting interior. A saw in the cutting interior cuts the workpiece. A carrier assembly holds and moves the workpiece in the cutting interior. The carrier assembly includes a rail assembly, a carriage assembly, a holder, a seal, and a fluid outlet. The rail assembly has a rail. The carriage assembly is supported and moveable along the rail. The holder is supported by and moveable with the carriage assembly along the rail. The holder holds the workpiece. The seal is support by and moveable with the carriage assembly. The seal is engaged with the rail assembly and slides along the rail assembly as the carriage assembly moves along the rail. The fluid outlet is arranged to direct fluid over the rail assembly to clear debris off the rail assembly.

The present invention generally relates to automated cutting systems, and more particularly to a carrier assembly for a workpiece in the automated cutting systems.

### BACKGROUND

Rising labor costs and demands for more time and cost-efficient construction have made it desirable to construct building components and modules off site at specialized fabrication facilities. These facilities may include automated cutting systems which cut workpieces, such as lumber, to various lengths and/or at various angles for use in constructing the building components.

### SUMMARY

In one aspect, a cutting system for a workpiece comprises a housing bounding a cutting interior. A saw is disposed in the cutting interior and is configured to cut the workpiece in the cutting interior. A carrier assembly is configured to hold the workpiece in the cutting interior and move the workpiece in the cutting interior. The carrier assembly includes a rail assembly, a carriage assembly, a holder, a seal, and a fluid outlet. The rail assembly includes a rail. The carriage assembly is supported by the rail and is moveable along the rail. The holder is supported by the carriage assembly and is moveable with the carriage assembly along the rail. The holder is configured to hold the workpiece. The seal is support by the carriage assembly and is moveable along the rail with the carriage assembly. The seal is engaged with the rail assembly and is arranged to slide along the rail assembly as the carriage assembly moves along the rail. A fluid outlet is arranged to direct fluid over the rail assembly to clear debris off the rail assembly.

In another aspect, a carrier assembly comprises a rail bounding a rail cavity having a mouth. A cover covers the mouth of the rail cavity and is configured to inhibit objects from moving into the rail cavity via the mouth. A carriage assembly is supported by the rail and is moveable along the rail. The carriage assembly includes a carriage and a fluid outlet. The carriage has opposite first and second ends. The cover extends out the carriage from the first and second ends. The fluid outlet is spaced from the first end of the carriage in a direction opposite the second end. The fluid outlet is arranged to direct fluid over the cover to clear objects off the cover as the carriage assembly moves along the rail. A drive train is connected to the carriage and is configured to move the carriage assembly along the rail.

In another aspect, a carrier assembly comprises a rail bounding a rail cavity having a mouth. A cover covers the mouth of the rail cavity and is configured to inhibit objects from moving into the rail cavity via the mouth. A carriage assembly is supported by the rail and is moveable along the rail. The carriage assembly includes a carriage and a bumper. The cover extends through the carriage. The carriage includes a cover guide forming an end of the carriage. The cover guide is configured to guide the cover into the carriage as the carriage assembly moves along the rail. The bumper is supported by the carriage and forms an end of the carriage assembly. The bumper includes a fluid outlet arranged to direct fluid over the cover to clear objects off the cover as the carriage assembly moves along the rail. A drive train is connected to the carriage and is configured to move the carriage assembly along the rail.

Other objects and features will be in part apparent and in part pointed out hereinafter.

### BRIEF DESCRIPTION OF THE DRAWINGS

FIG. 1 is a perspective of a cutting system according to one embodiment of the present disclosure;

FIG. 2 is an enlarged, fragmentary perspective of the cutting system with portions cut away to show interior details;

FIG. 3 is another enlarged, fragmentary perspective of the cutting system from a vantage opposite to that of FIG. 2, with portions cut away to show interior details;

FIG. 4 is an enlarged, fragmentary perspective of a carrier assembly of the cutting system;

FIG. 5 is a perspective of the carrier assembly;

FIG. 6 is an enlarged, fragmentary perspective of the carrier assembly, including a carriage assembly and a rail assembly thereof;

FIG. 7. is a cross-sectional perspective of the carriage assembly and the rail assembly;

FIG. 8 is a cross-section of the carriage assembly and the rail assembly;

FIG. 9 is a perspective of a bumper of the carriage assembly; and

FIG. 10 is a schematic diagram of the cutting system.

Corresponding parts are indicated by corresponding reference characters throughout the several views of the drawings.

### DETAILED DESCRIPTION

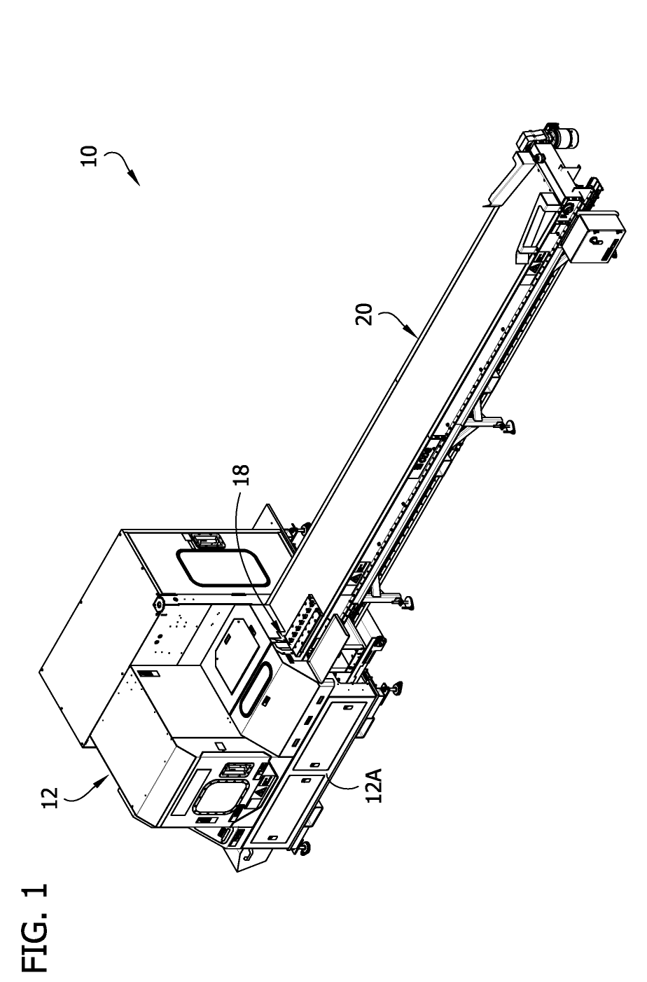

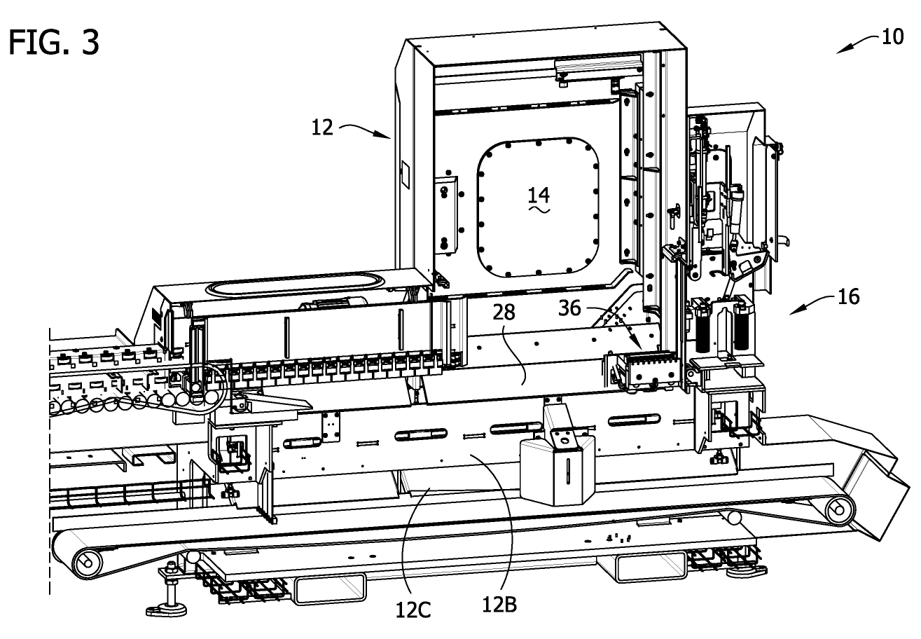

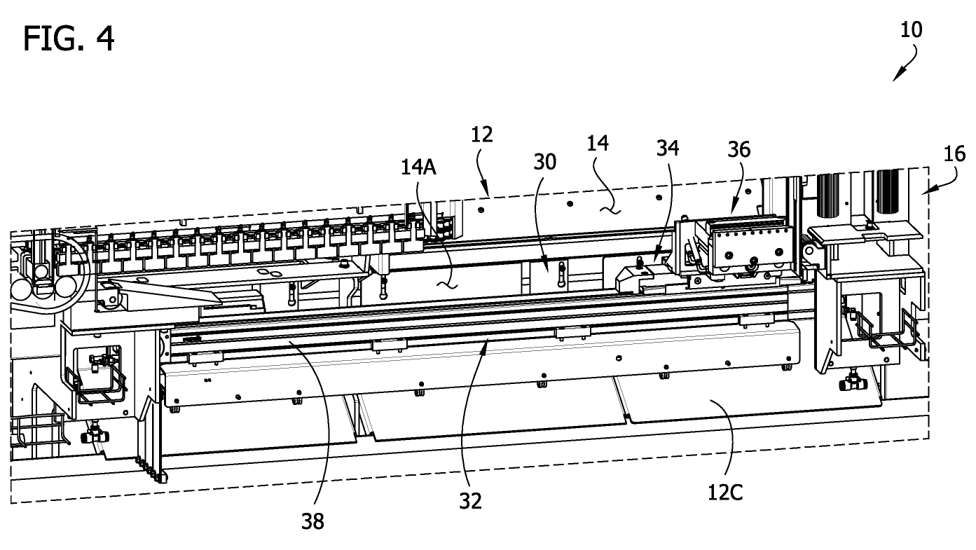

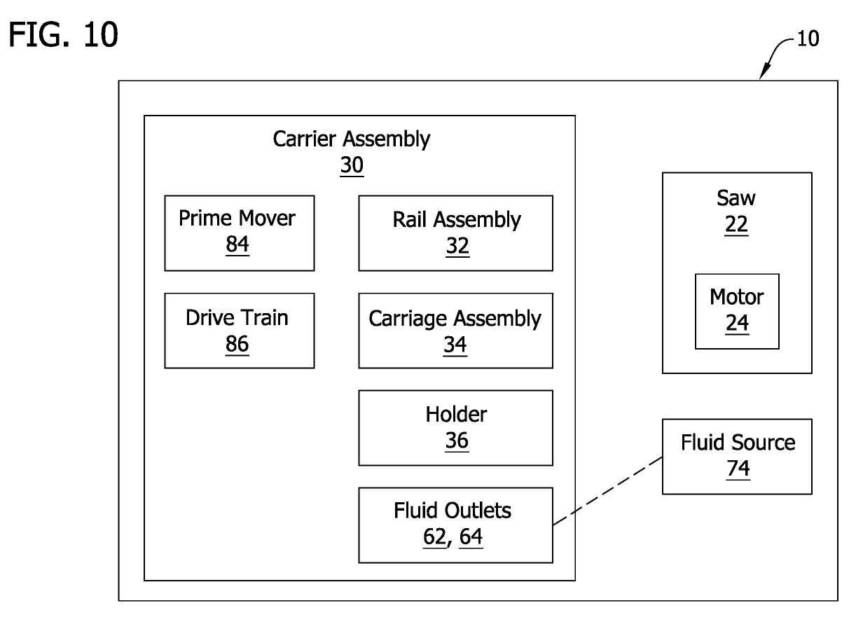

Referring to FIGS. 1-4, a cutting system (e.g., automated cutting system) according to one embodiment of the present disclosure is generally indicated at reference numeral 10. The cutting system 10 is used to cut workpieces, such as lumber or other material, to desired lengths with cuts made at desired angles. As an example, the cutting system 10 may cut lumber to form truss members used to make a truss, although it is understood the cutting system can be used to cut members used to form other constructs. The cutting system 10 can cut the workpieces according to predetermined instructions entered by an operator. The cutting system 10 may cut workpieces one at a time, or multiple workpieces simultaneously. The cutting system 10 includes a housing 12 bounding a cutting interior 14. The housing 12, desirably, generally encloses the cutting interior 14. The housing 12 includes an infeed opening 16 (FIG. 3) and an outfeed opening 18 (FIG. 10). The workpieces enter cutting interior 14 via the infeed opening 16 and leave the cutting interior via the outfeed opening 18. The workpieces can be manually inserted into the infeed opening or delivered using other machinery (not shown), such as an infeed conveyor or loader. Further details on infeed conveyors can be found in U.S. Pat. Nos. 7,011,006 and 11,691,310, the entireties of which are herein incorporated by reference. In the illustrated embodiment, the cutting system 10 includes an outfeed conveyor 20 (e.g., conveyor belt) that receives the workpieces from the outfeed opening 18 and transports the workpieces away from the outfeed opening.

The cutting system 10 includes a saw 22 disposed in the cutting interior 14. The saw 22 cuts the workpieces in the cutting interior 14. The saw 22 is desirably a multi-position saw capable of cutting a workpiece at any angle and to any length. The saw 22 includes a motor 24 and a saw blade 26 rotated by the motor to cut the workpiece. The saw 22 cuts the workpiece to the desired length with the desired angled miter cuts at one or each end, such as to form the truss member.

The cutting system 10 includes a carrier assembly 30. The carrier assembly 30 holds the workpiece in the cutting interior and/or moves the workpiece in the cutting interior. For example, the carrier assembly 30 can hold the workpiece while the saw 22 is cutting the workpiece. The carrier assembly can also move the workpiece within the cutting interior, such as toward the outfeed opening 18 to discharge the workpiece. The cutting system 10 may include other components (e.g., rollers, clamps, etc.) to hold and/or move the workpiece in the cutting interior 14. Although described in the context of the cutting system 10, it is understood the carrier assembly 30 (and components thereof) can be used in other contexts without departing from the scope of the present disclosure.

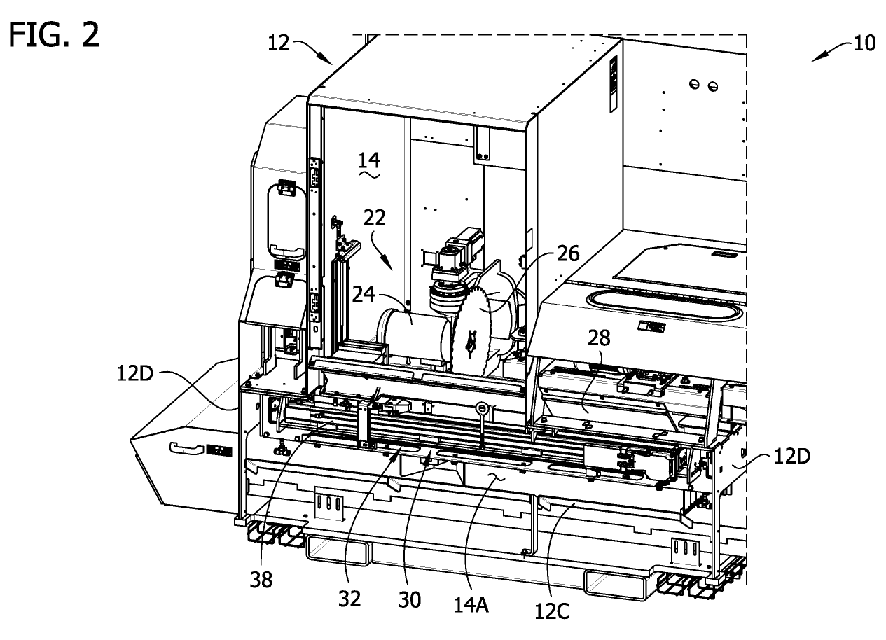

The carrier assembly 30 is disposed in the cutting interior 14. In other embodiments, the carrier assembly 30 may only be partially disposed in the cutting interior. In the illustrated embodiment, the carrier assembly 30 is disposed within a section 14A (e.g., carrier section) of the cutting interior 14. The housing 12 includes one or more interior walls which bound the carrier section 14A and separate the carrier section from the rest of the cutting interior 14. In the illustrated embodiment, the carrier section 14A is bound by a front wall 12A (FIG. 1) of the housing 12, a side interior wall 12B (FIG. 3) in the cutting interior 14, an angled or ramped bottom interior wall 12C in the cutting interior, and opposite end walls 12D (FIG. 2). The cutting system 10 includes one or more brushes 28 (shown schematically in FIGS. 2 and 3 as solid walls) that form a brush wall bounding a top of the carrier section 14A. The brushes 28 (and other interior walls) are configured to help inhibit debris (e.g., dust, saw dust, shavings) formed during the cutting of the workpiece by the saw 22 from entering the carrier section 14A and preventing the carrier assembly 30 from operating properly (such as due to an excessive build-up of debris). The brushes 28 also allow the carrier assembly 30 to extend there-through (from the carrier section 14A into the rest of the cutting interior 14) to engage the workpiece. The brushes 28 extend at an angle to the horizontal and vertical to facilitate debris falling off the brushes.

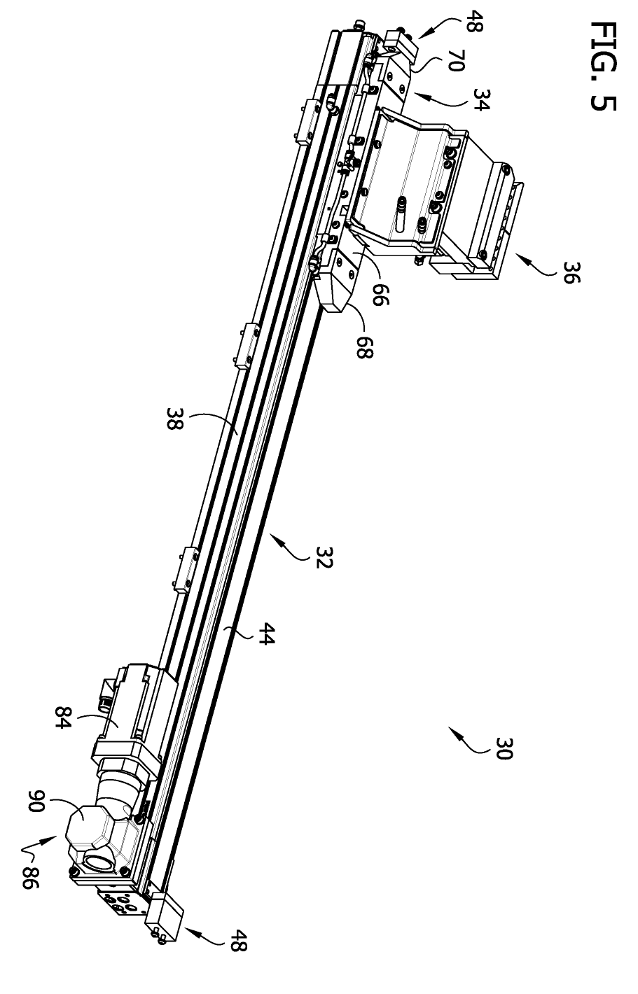

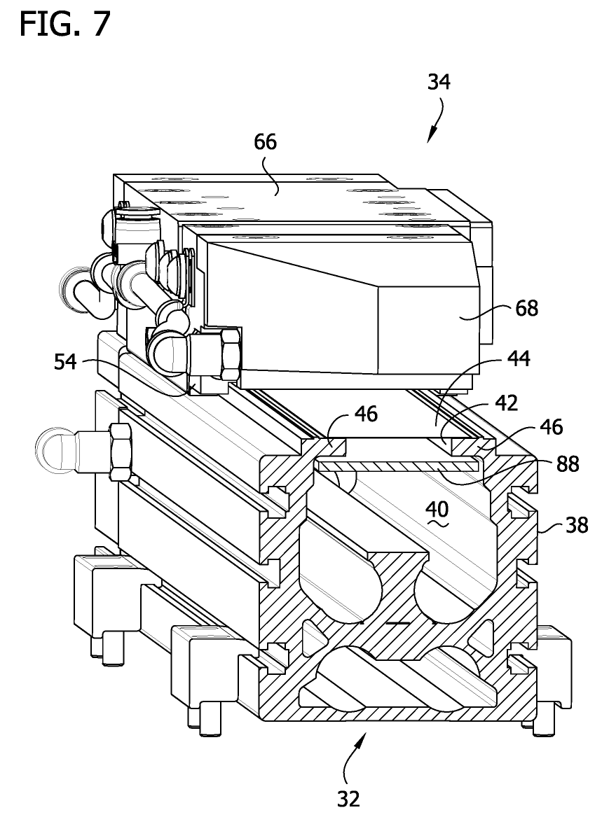

Referring to FIGS. 5-9, the carrier assembly 30 includes a rail assembly 32, a carriage assembly 34, and a gripper or holder 36. The rail assembly 32 is disposed in the carrier section 14A of the cutting interior 14. In other embodiments, the rail assembly 32 may only be partially disposed in the carrier section. The rail assembly 32 includes a rail 38. The rail 38 defines a track or pathway along which the carriage assembly 34 moves. In the illustrated embodiment, the pathway (generally, the rail 38) is linear or straight. As shown in FIG. 7, the rail 38 has a generally U-shape. The rail 38 has (e.g., bounds) a rail cavity or channel 40 (FIG. 7). The rail cavity 40 generally extends from one end of the rail 38 to the other. The rail cavity 40 contains various other components of the carrier assembly 30, as will be described. The rail cavity 40 has a mouth 42 at the upper side of the rail cavity (e.g., along the upper side of the rail 38). The rail 38 can be an extruded component, such as a piece of extruded metal (e.g., aluminum).

The rail assembly 32 includes a cover 44 (e.g., cover strip). The cover 44 is arranged to block debris (generated by the saw 22) from entering the rail cavity 40 via the mouth 42. It is possible for debris to enter the carrier section 14A of the cutting interior 14, such as through gaps in the brushes 28 (e.g., bristles thereof) and/or other openings/gaps (such as in the interior walls). The cover 44 prevents the debris that enters the carrier section 14A from entering and settling in the rail cavity 40. This prevents debris (e.g., a build-up thereof) in the rail cavity 40 from interfering with the operation of components of the carrier assembly 30 (e.g., drive train) in the rail cavity. For example, the debris could cause one or more components of the carrier assembly 30 in the rail cavity 40 to jam or otherwise become stuck. Thus, the cover 44 covers the mouth 42 of the rail cavity 40 configured to inhibit debris (broadly, objects) from moving into the rail cavity via the mouth. The cover 44 extends from one end of the rail 38 to the other, to cover the full length of the mouth 42. In the illustrated embodiment, the cover 44 overlies the mouth 42 of the rail cavity 40 and rests on opposite upper flanges 46 of the rail 38 that define the opposite sides of the mouth. Each end of the cover 44 is fixed or otherwise immovably secured to the rail 38, such as with one or more fasteners (not shown). The cover 44 can be made of any suitable material, such as metal (e.g., steel, aluminum, etc.) or plastic, and in one embodiment is made of stainless steel.

The carriage assembly 34 is supported by the rail assembly 32, specifically the rail 38. The carriage assembly 34 is moveable along the rail 38 (e.g., the length thereof). The carriage assembly 34 can move back-and-forth along the rail 38 from one end of the rail to the other. The carrier assembly 30 can include stops 48 at each end of the rail 38 arranged to engage the carriage assembly 34 and stop further movement of the carriage assembly along the rail. The carriage assembly 34 includes a carriage 50. The carriage 50 engages and slides along the rail 38. The carriage 50 includes a main or carriage body 52, a first cover guide 54, and a second cover guide 56. The main body 52 rests on the rail 38 and extends into the rail cavity 40 (via the mouth 42). The main body 52 is illustrated as a single, integral piece but in other embodiments can be multiple pieces joined together. The first cover guide 54 is supported by and connected to main body 52 and forms one end (e.g., a first end) of the carriage 50. The second cover guide 56 is supported by and connected to the main body 52 and forms the opposite end (e.g., a second end) of the carriage 50. The cover 44 extends through (e.g., into one end and out the other end) of the carriage 50. The cover 44 extends out of the carriage 50 from the opposite first and second ends (e.g., from the first and second cover guides 54, 56). The first and second cover guides 54, 56 are generally identical (e.g., mirror images of one another). Each cover guide 54, 56 guides the cover 44 into (and out of) the carriage 50 (e.g., main body 52), specifically as the carriage assembly 34 moves along the rail 38. Each cover guide 54, 56 may include opposite side rails which generally extend along the outer sides of the flanges 46 of the rail 38 (and opposite side edges of the cover) and inhibit or limit the cover 44 from moving sideways or laterally relative to the rail (see FIG. 7).

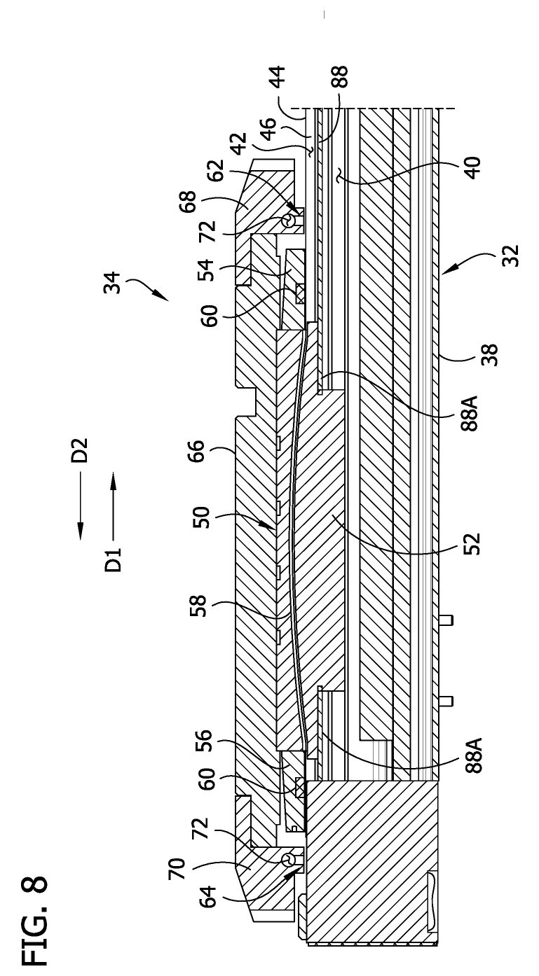

The carriage 50 (specifically, the main body 52) (broadly, the carriage assembly 34) moves a portion of the cover 44 away from the mouth 42 of the rail cavity 40 as the carriage moves along the rail 38. In other words, the carriage 50 lifts the portion of the cover 44 that extends through the carriage off the rail 38. This allows the carriage 50 (specifically, the main body 52) (broadly, the carriage assembly 34) to extend into the rail cavity 38, in order to connect to components or elements therein such as the drive train and/or rail. It is appreciated that the portion of the cover 44 moved (e.g., moved upward) away from the mouth 42 of the rail cavity 40 will change as the carriage assembly 34 moves along the rail 38. Each cover guide 54, 56 can also help bias or push the cover 44 (e.g., portions of the cover outside the carriage 50) toward or into engagement with the top (e.g., top surface) of the rail 38 (e.g., flanges 46), to prevent the passage of debris between the cover and the rail. The main body 52 includes a cover passage or channel 58 (FIG. 8) through which the cover 44 extends. The main body 52 extends around the cover 44 and out of the rail cavity. As a result, the cover 44 is lifted out of contact with the rail 38 to permit passage of the main body 52 out of the rail cavity. The cover 44 extends under each cover guide 54, 56 and into the cover passage 58, where the main body 52 engages and lifts the cover upward off the rail 38.

Referring to FIG. 8, in one embodiment the carriage assembly 34 can include one or more seals or wipers 60 engaged with cover 44 (broadly, rail assembly). In the illustrated embodiment, the carriage assembly 34 has two seals 60, one adjacent to each end of the carriage 50, are shown. The illustrated seals 60 are supported and carried by the cover guides 54, 56 (broadly, the carriage assembly 34). Each seal 60 slides along the cover 44 (broadly, the rail assembly 32) as the carriage assembly 34 moves along the rail 38. The seals 60 inhibit debris on the cover 44 from entering the cover passage 58 in the main body 52 and from moving into the rail cavity 40 due to any gaps formed between the cover 44 and the rail 38 when the cover is lifted off the rail by the carriage 50. As the carriage assembly 34 moves along the rail 38, the seals 60 push any debris on the cover 44 along (and off) the cover (broadly, push debris along and off the rail assembly 32). The seals 60 can also push the cover 44 against the rail 38 (specifically, against the top of the flanges 46) to limit further gaps formed between the cover and the rail when the cover is lifted off the rail by the main body 52. In one embodiment, each seal 60 comprises a strip of felt or similar material extending across the cover 44, although other configurations of the seal can be used without departing from the scope of the present disclosure.

The carriage assembly 34 includes a mount or mounting plate 66 attached to the carriage 50, such as with one or more fasteners. The mount 66 overlies the carriage 50 and is used to mount or connect the holder 36 to the carriage assembly 34. The carriage assembly 34 also includes first and second bumpers 68, 70. The first bumper 68 is supported by carriage 50 and forms one end (e.g., a first end) of the carriage assembly 34. The second bumper 70 is supported by the carriage 50 and forms the opposite end (e.g., a second end) of the carriage assembly 34. In the illustrated embodiment, each bumper 68, 70 is connected to the mount 66 with one or more fasteners. The first bumper 68 extends outward of the first cover guide 54 (the first end of the carriage 50) in a first direction D1. The second bumper 70 extends outward of the second cover guide 56 (the second end of the carriage 50) in a second direction D2, which is opposite the first direction D1. The carriage assembly 34 moves back-and-forth along the rail 38 in the first and second directions D1, D2. Each bumper 68, 70 is positioned to engage one of the stops 48 when the carriage assembly 34 is at one of the ends of the rail 38. Each bumper 68, 70 includes a stop or engagement surface or end 71 positioned to hit one of the stops 48. The engagement surface 71 for each of the first and second bumpers 68, 70 is disposed outward in the respective first or second direction D1, D2 of the respective first or second cover guide 54, 56. The engagement surfaces 71 form the opposite ends of the carriage assembly 34. The first and second bumpers 68, 70 are generally identical (e.g., mirror images of one another). Each bumper 68, 70 can be made of any suitable material, such as an elastomeric material (e.g., rubber), metal (e.g., steel, aluminum, etc.), or plastic. Other configurations of the carriage assembly (and components thereof) can be used without departing from the scope of the present disclosure.

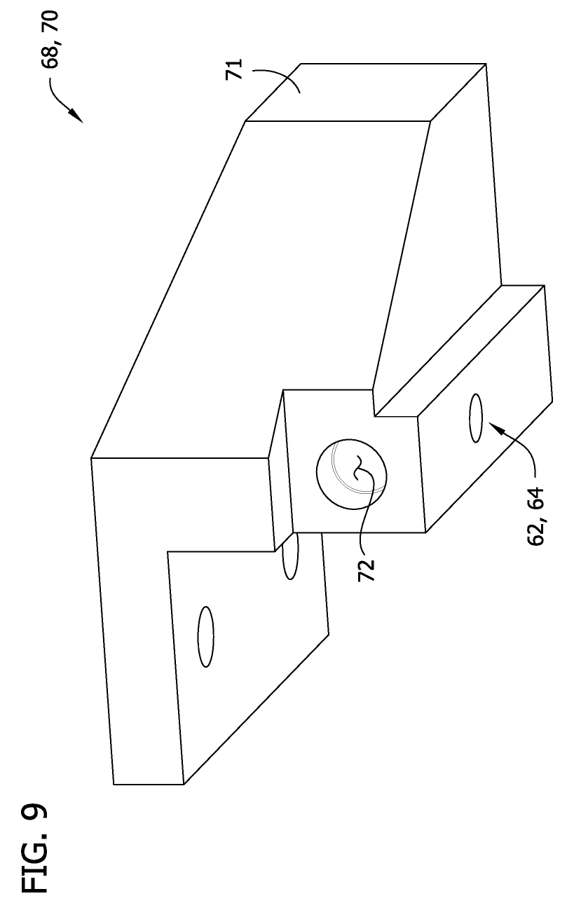

Referring to FIGS. 8 and 9, the carrier assembly 30 includes a first fluid outlet 62 and a second fluid outlet 64 (broadly, one or more fluid outlets). Each fluid outlet 62, 64 directs fluid (e.g., air) over the rail assembly 32 to clear debris off the rail assembly. Specifically, each fluid outlet 62, 64 directs fluid onto or over the cover 44 to clear debris off the cover as the carriage assembly 34 moves along the rail 38. This prevents the debris from entering and building up in the carriage 50 and from moving into the rail cavity 40 due to any gaps formed between the cover 44 and the rail 38 when the cover is lifted off the rail by the carriage 50. In the illustrated embodiment, the first and second fluid outlets 62, 64 each direct the fluid vertically downward onto the rail assembly 32 (e.g., cover 44). Desirably, the first and second fluid outlets 62, 64 are moveable along the rail 38. Preferably, the first and second fluid outlets 62, 64 are supported by and moveable with the carriage assembly 34 (e.g., are a part of the carriage assembly). The first fluid outlet 62 is adjacent the first end of the carriage assembly 34 and the second fluid outlet 64 is adjacent the second end of the carriage assembly. In the illustrated embodiment, each bumper 68, 70 forms (e.g., includes) one of the fluid outlets 62, 64. The first bumper 68 forms the first fluid outlet 62 and the second bumper 70 forms the second fluid outlet 64.

The fluid outlets 62, 64 are arranged relative to the seals 60 such that the fluid outlets direct fluid over the rail assembly 32 to clear debris off the rail assembly before the debris reaches the seals as the carriage assembly 34 moves along (e.g., back-and-forth along) the rail 38. The first fluid outlet 62 is spaced from the first end of the carriage 50 (e.g., the first cover guide 54) in the first direction D1 (which is opposite the second end of the carriage). This position allows the first fluid outlet 62 to blow off debris on the cover 44 before the debris reaches the carriage 50 (in particular the first seal 60) when the carriage assembly 34 is traveling in the first direction D1. The first seal 60 (connected to the first cover guide 54) is spaced from the first fluid outlet 62 in the second direction D2. This position allows the first seal 60 to stop any debris not blown off by the first fluid outlet 62 from reaching the cover passage 58 and from moving into the rail cavity 40 (as described above). The second fluid outlet 64 is spaced from the second end of the carriage 50 (e.g., the second cover guide 56) in the second direction D2 (which is opposite the first end of the carriage). This position allows the second fluid outlet 64 to blow off debris on the cover 44 before the debris reaches the carriage 50 (in particular the second seal 60) when the carriage assembly 34 is traveling in the second direction D2. The second seal 60 (connected to the second cover guide 56) is spaced from the second fluid outlet 64 in the first direction D1. This position allows the second seal 60 to stop any debris not blown off by the second fluid outlet 64 from reaching the cover passage 58 and from moving into the rail cavity 40 (as described above). In the illustrated embodiment, each fluid outlet 62, 64 comprises a single circular opening generally centered widthwise over the cover 44. Other configurations of the fluid outlets can be used without departing from the scope of the present disclosure. For example, the fluid outlets can comprise a plurality of openings and/or have a slot (e.g., elongate) shape.

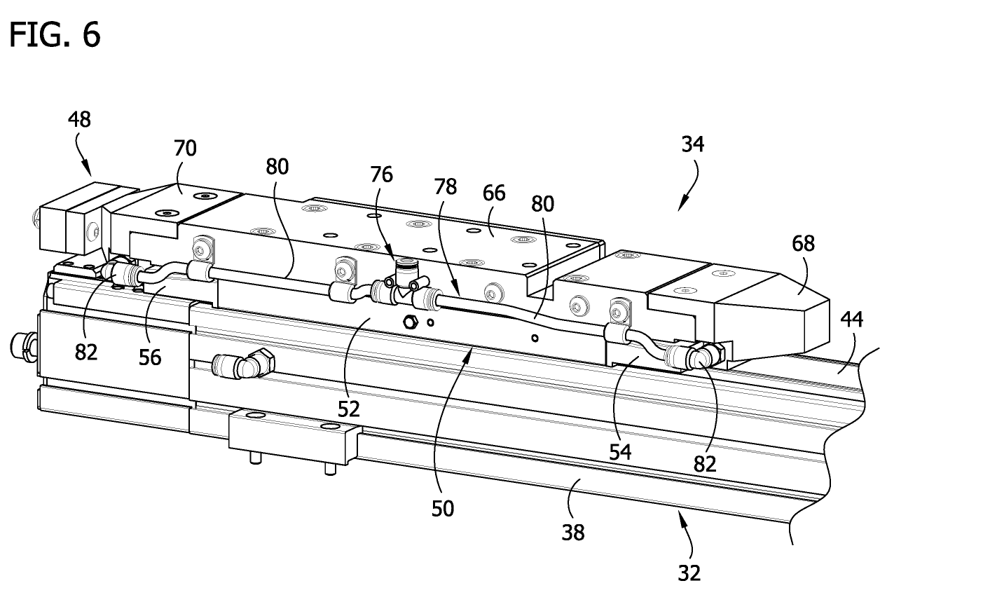

The cutting system 10 includes a fluid source 74 (FIG. 10) that supplies the fluid (e.g., air) to the fluid outlets 62, 64. The fluid source 74 may comprise an air compressor, fan, blower, or any other suitable device for moving the fluid to the fluid outlets. The fluid source 74 is fluidly coupled to the fluid outlets 62, 64, such as by hoses, conduits, tubes, ducts, fitting, connectors, and/or combinations thereof. With reference to FIG. 6, in the illustrated embodiment, the carrier assembly 30 includes a fluid connector or fitting 76 (e.g., a T-fitting) and fluid passaging 78 extending between and fluidly connecting the fluid connector to the fluid outlets 62, 64. The fluid connector 76 is supported by the carriage 50, specifically mounted to the mount 66. The fluid connector 76 is configured to be fluidly connected to the fluid source 74 for delivering fluid to the fluid outlets 62, 64. In the illustrated embodiment, the fluid connector 76 is connectable to a hose or conduit that guides fluid supplied by the fluid source 74 into the fluid connector. The fluid passaging 78 is also supported by the carriage 50. The fluid passaging 78 includes conduits 80, one for each fluid outlet 62, 64 and extending from the fluid connector 76. The fluid passaging 78 includes fluid passageways 72 defined by each bumper 68, 70 leading to (e.g., fluidly connected directed with) respective fluid outlets 62, 64. The fluid passaging 78 includes fittings 82 (e.g., elbow or 90-degree fittings) interconnecting each conduit 80 to its respective fluid passageway 72 in one of the bumpers 68, 70. The conduits 80 are mounted to the mount 66 and the fittings 82 are mounted to their respective bumpers 68, 70. Thus, the fluid connector 76 and fluid passaging 78 travels with the carriage assembly 34 along the rail 38. Other configurations of the fluid connector and fluid passaging can be used without departing from the scope of the present disclosure. In one embodiment, the fluid passageway 72 and fluid outlets 62, 64 are formed in each bumper 68, 70 by drilling one or more (e.g., two) blind bores (e.g., bores that do not extend all the way through a component) that intersect one another. For example, the portion of the fluid passageway 72 connected to the fitting 82 can be formed by a first blind bore and the fluid outlet 62, 64 and remaining portion of the fluid passageway 72 can be formed by a second blind bore that connects to (e.g., intersects) the first blind bore. The second blind bore extends at a non-zero angle (such as skew angle) relative to the first blind bore. In one embodiment, the second blind bore extends generally perpendicular to the first blind bore. Other ways of forming the fluid passageway and/or fluid outlets can be used without departing from the scope of the present disclosure.

Referring to FIGS. 3-5, the holder 36 is supported by the carriage assembly 34 and moves with the carriage assembly along the rail 38. The holder 36 is mounted to the mount 66, such as with one or more fasteners. The holder 36 (e.g., a bracket or base thereof) extends through the one or more brushes 28 (e.g., brush wall). Thus, the holder 36 extends out of the carrier interior 14A into the rest of the cutting interior 14. As the carriage assembly 34 moves along the rail 38, the holder 36 moves in the one or more brushes 28, pushing the brushes (e.g., bristles thereof) out of the way as needed. The holder 36 holds or grips the workpiece. For example, in the illustrated embodiment, the holder 36 clamps the workpiece between two plates (e.g., a stationary plate and a moveable plate). The holder 36 includes one or more linear actuators (e.g., electric or pneumatic linear actuator) that moves one or both of the plates towards and away from one another to selectively grip and release the workpiece. Other configurations of the holder can be used without departing from the scope of the present disclosure.

Referring to FIGS. 5-8, the carrier assembly 30 includes a prime mover 84 (e.g., an electric or pneumatic motor) and a drive train 86 for moving the carriage assembly 34 back-and-forth along the rail 38. The drive train 86 operatively connects the prime mover 84 to the carriage assembly 34. The drive train 86 is connected to the carriage assembly 34 (specifically, the carriage 50, more specifically the main body 52) and the prime mover 84. The drive train moves the carriage assembly along the rail 34 when driven by the prime mover 84. The drive train 84 is disposed in (e.g., at least partially disposed in) the rail cavity 40 of the rail 38. In the illustrated embodiment, the drive train 86 comprises a belt 88. The belt is disposed in (e.g., at least partially disposed in) the rail cavity 40. Each end portion 88A of the belt 88 is attached to the carriage assembly 34 (specifically, the carriage 50, more specifically the main body 52). In particular, each end portion 88A of the belt 88 is attached to the carriage assembly 34 at a location within the rail cavity 40 (below the mouth 42) as shown in FIG. 8 (broadly, the drive train 86 is connected to the carriage assembly at a location within the rail cavity). In one embodiment, each end portion 88A of the belt 88 is attached to the main body 52 with one or more fasteners, which may or may not be used in combination with washers, blocks, or strips which compress each end portion against the main body. Other ways of connecting the belt 88 to the carriage assembly 34 can be used without departing from the scope of the present disclosure. The drive train 86 includes two wheels (not shown), one at each end of the rail assembly 32 that the belt 88 wraps around. The wheels may also be disposed in the rail cavity 40. The drive train 86 includes a transmission 90 (e.g., shafts and/or gears) that transfers rotational movement from the prime mover 84 directly to one or both of the wheels to move the belt 88 and thereby the carriage assembly 34. The rotational output of the prime mover 84 is reversible to move the carriage assembly 34 back-and-forth along the rail 38. Other types of drive trains and/or prime movers can be used without departing from the scope of the present disclosure. For example, the drive train can comprise a screw drive instead of a belt.

The cover 44 prevents debris from entering the rail cavity 40 and inhibiting or interfering with the operation of the drive train (e.g., the belt 88, wheels, etc.). This also prevents debris from interfering with the sliding of the carriage assembly 34 (e.g., carriage 50) along the rail 38. In the illustrated embodiment, the carriage 50 (e.g., main body 52 thereof) is slidably connected to the rail 38 by extending through the mouth 42 and into the rail cavity 40. The carriage 50 can engage one or more interior surfaces of the rail 38 bounding the rail cavity 40 to inhibit the carriage from lifting off the rail. For example, the carriage 50 can include flanges which underlie the flanges 46 of the rail 38. The debris can also interfere with this slidable connection between the carriage 50 and the rail 38.

Having described the disclosure in detail, it will be apparent that modifications and variations are possible without departing from the scope of the disclosure defined in the appended claims.

When introducing elements of the present disclosure or the preferred embodiment(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the disclosure are achieved and other advantageous results attained.

As various changes could be made in the above products without departing from the scope of the disclosure, it is intended that all matter contained in the above description and shown in the accompanying drawings shall be interpreted as illustrative and not in a limiting sense.

What is claimed is:

1. A cutting system for a workpiece, the cutting system comprising:
a housing bounding a cutting interior;
a saw disposed in the cutting interior and configured to cut the workpiece in the cutting interior;
a carrier assembly configured to hold the workpiece in the cutting interior and move the workpiece in the cutting interior, the carrier assembly including:
a rail assembly including a rail;
a carriage assembly supported by the rail and moveable along the rail;
a holder supported by the carriage assembly and moveable with the carriage assembly along the rail, the holder configured to hold the workpiece;
a seal support by the carriage assembly and moveable along the rail with the carriage assembly, the seal engaged with the rail assembly and arranged to slide along the rail assembly as the carriage assembly moves along the rail; and
a fluid outlet arranged to direct fluid over the rail assembly to clear debris off the rail assembly.

2. The cutting system of claim 1, wherein the fluid outlet is moveable along the rail.

3. The cutting system of claim 1, wherein the fluid outlet is supported by and moveable with the carriage assembly.

4. The cutting system of claim 1, wherein the fluid outlet is arranged to direct the fluid vertically downward onto the rail assembly.

5. The cutting system of claim 1, wherein the fluid outlet is arranged relative to the seal such that the fluid outlet directs fluid over the rail assembly to clear debris off the rail assembly before the debris reaches the seal as the carriage assembly moves along the rail in one direction.

6. The cutting system of claim 1, wherein the rail bounds a rail cavity having a mouth, the rail assembly includes a cover arranged to block debris from entering the rail cavity via the mouth, the fluid outlet being arranged to direct the fluid onto the cover, the seal engaging the cover and arranged to slide along the cover as the carriage assembly moves along the rail.

7. The cutting system of claim 6, wherein the carriage assembly is configured to move a portion of the cover away from the mouth as the carriage assembly moves along the rail.

8. The cutting system of claim 7, wherein the carrier assembly includes a drive train disposed in the rail cavity and configured to move the carriage assembly along the rail, the carriage assembly being connected to the drive train at a location within the rail cavity.

9. The cutting system of claim 1, further comprising a fluid source configured to supply the fluid to the fluid outlet.

10. The cutting system of claim 1, wherein the housing includes an interior wall and one or more brushes bounding a section of the cutting interior, the rail of the carrier assembly being disposed in the section of the cutting interior, the holder extending through the one or more brushes.

11. A carrier assembly comprising:
a rail bounding a rail cavity having a mouth;
a cover covering the mouth of the rail cavity configured to inhibit objects from moving into the rail cavity via the mouth;
a carriage assembly supported by the rail and moveable along the rail, the carriage assembly including a carriage and a fluid outlet, the carriage having opposite first and second ends, the cover extending out the carriage from the first and second ends, the fluid outlet being spaced from the first end of the carriage in a direction opposite the second end, the fluid outlet being arranged to direct fluid over the cover to clear objects off the cover as the carriage assembly moves along the rail; and
a drive train connected to the carriage and configured to move the carriage assembly along the rail.

12. The carrier assembly of claim 11, wherein the fluid outlet is a first fluid outlet and the direction is a first direction, the carriage assembly including a second fluid outlet being spaced from the second end of the carriage in a second direction opposite the first direction and the first end, the second fluid outlet being arranged to direct fluid over the cover to clear objects off the cover as the carriage assembly moves along the rail.

13. The carrier assembly of claim 12, wherein the carriage includes first and second cover guides forming the respective first and second ends of the carriage, the first and second cover guides each guiding the cover into the carriage.

14. The carrier assembly of claim 13, wherein the first fluid outlet is spaced from the first cover guide in the first direction and the second fluid outlet is spaced from the second cover guide in the second direction.

15. The carrier assembly of claim 11, wherein the direction is a first direction, and wherein the carriage assembly includes a seal engaged with the cover, the seal being spaced from the fluid outlet in a second direction opposite the first direction, the seal arranged to slide along the cover as the carriage assembly moves along the rail.

16. A carrier assembly comprising:
a rail bounding a rail cavity having a mouth;
a cover covering the mouth of the rail cavity configured to inhibit objects from moving into the rail cavity via the mouth;
a carriage assembly supported by the rail and moveable along the rail, the carriage assembly including a carriage and a bumper, the cover extending through the carriage, the carriage including a cover guide forming an end of the carriage and configured to guide the cover into the carriage as the carriage assembly moves along the rail, the bumper being supported by the carriage and forming an end of the carriage assembly, the bumper including a fluid outlet arranged to direct fluid over the cover to clear objects off the cover as the carriage assembly moves along the rail; and
a drive train connected to the carriage and configured to move the carriage assembly along the rail.

17. The carrier assembly of claim 16, wherein the cover guide is a first cover guide, the bumper is a first bumper, and the fluid outlet is a first fluid outlet, the carriage including a second cover guide forming another end of the carriage and configured to guide the cover into the carriage as the carriage assembly moves along the rail, the carriage assembly including a second bumper supported by the carriage and forming another end of the carriage assembly, the second bumper including a second fluid outlet arranged to direct fluid over the cover to clear objects off the cover as the carriage assembly moves along the rail.

18. The carrier assembly of claim 17, wherein the first fluid outlet is spaced apart from first cover guide in a first direction and the second fluid outlet is spaced apart from said second cover guide in a second direction opposite the first direction.

19. The carrier assembly of claim 16, wherein the carriage assembly includes a seal engaged with the cover and arranged to slide along the cover as the carriage assembly moves along the rail.

20. The carrier assembly of claim 16, further comprising a fluid connector and fluid passaging extending between and fluidly connecting the connector and the fluid outlet, the fluid connector being configured to be fluidly connected to a fluid source for delivering fluid to the fluid outlet.
